(19) United States
(12) Patent Application Publication
(10) Pub. No.: US 2006/0072239 A1
(43) Pub. Date: Apr. 6, 2006

(54) Portable memory system and device

(76) Inventor: Syed H. Iftikar, Pleasanton, CA (US)

Correspondence Address: PATRICK REILLY, BOX 7218, SANTA CRUZ, CA, 95061-7218, US

(21) Appl. No.: 11/210,150

(22) Filed: Aug. 23, 2005

Related U.S. Application Data
(60) Provisional application No. 60/603,921, filed on Aug. 23, 2004.

(51) Int. Cl. G11B 5/012; G11B 17/00

(52) U.S. Cl. 360/97.01

(57) ABSTRACT

A solid state memory disk drive device and system are provided. A first preferred embodiment of the present invention comprises (1) at least one digital memory disk located within an enclosure, (2) a motor for rotating the disk(s) about an axis of motion substantially normal to the disk(s), (3) one or more data heads, (4) a signal pathway communicatively coupling the data heads(s) to an electronic device or an electronic system, (5) a means for an external electronic device or system to position the data head(s) relative to the digital memory disk(s) to read from or optionally write to a location of one or more disks, and (6) a control means for the external device or system to operate the present invention. The enclosure may optionally surround the disk(s) and hermetically seal the disk(s) within the enclosure.

### FIELD OF THE INVENTION

The present invention relates to digital data memory devices, and in particular, to disk drive devices and systems that enable the portability of digital data memory modules.

### BACKGROUND OF THE INVENTION

A digital memory disk drive system includes one or more memory bearing disks, such as optical disks or magnetic disks, each configured for storing digital data. Such disks are positioned within an enclosure and mounted on a rotational member of a motor. A data head is provided to read and/or write from and optionally to the disk. Means are provided for each data head to be controllably positioned relative to a corresponding disk in order to read from digital data or write digital data to a selected location of the disk. A data pathway enables data read from the disk to be communicated from and optionally to each data head and to an external device or system, such as a personal computer. An interface controller provides means for the external electronic device to operate the disk drive system.

In recent years, it has become increasingly commercially significant to provide high capacity and lower cost hard disk drive devices. The prior art has allowed for placing the disks in a removable cartridge, and locating an interface controller outside of the cartridge, whereby the cost of the disk drive cartridge is reduced. However, the cost of the removable drive is significantly higher than standard fixed hard drives. It is therefore an object of the present invention to split the cost of a fixed hard drive system into a control system part and a head disc assembly part called the cartridge. Such a system will have a low removable drive cost and will be cost effective in applications that use multiple cartridges.

### SUMMARY OF THE INVENTION

These and other objects are achieved by the method of the present invention that provides a hard disk drive device and system. A first preferred embodiment of the present invention comprises (1) at least one digital memory disk located within an enclosure, (2) a motor for rotating the disk(s) about an axis of motion substantially normal to the disk(s), (3) one or more data heads, each data head configured to read data from, and optionally write data to, a corresponding digital memory disk, (4) a signal pathway communicatively coupling the data heads(s) to an electronic device or an electronic system, (5) a means for an external electronic device or system to position the data head(s) relative to the digital memory disk(s) to read from or optionally write to a location of one or more disks, and (6) a control means for the external device or system to operate the present invention. The enclosure may optionally surround the disk(s) and hermetically seal the disk(s) within the enclosure. In one or more certain preferred embodiments of the present invention one or more digital memory disks may be an optical memory disk or a magnetic disk, or a plurality of disks comprising a combination of optical disk(s) and magnetic disk(s). The means for the external device or system to control the positioning of the data head(s) relative to a corresponding disk or disks may optionally include a magnetically responsive element mechanically coupled with the data head(s).

A second preferred embodiment of the present invention comprises a (1) at least one digital memory disk located within an enclosure, (2) a motor for rotating the disk(s) about an axis of motion substantially normal to the disk(s), (3) one or more data heads, each data head configured to read data from, and optionally write data to, a corresponding digital memory disk, (4) a magnetically responsive coil element mechanically coupled with the data head(s) (5) a magnetic field generator, (6) a signal pathway communicatively coupling the data heads(s) to an electronic device or an electronic system, and (7) a control means for the external device or system to operate the present invention.

A third preferred embodiment of the present invention comprises a cartridge and a docking station, wherein the cartridge may be detachably coupled with the docking station and the docking station is communicatively coupled with an external electronic device or system. The cartridge has one or more digital memory disks, a motor coupled with the disk(s) and for rotating the disk(s), and a corresponding data head for each disk as well as a magnetically responsive element coupled with the data heads. The docking station may comprise an interface controller communicatively coupled with the external device or system, and for enabling the external device or system to control the operation of the cartridge, such as the state of the cartridge motor and the position of the data head(s) relative to each corresponding digital memory disk.

A fourth preferred embodiment of the present invention comprises a cartridge and a docking station, wherein the cartridge may be detachably coupled with the docking station. The cartridge has one or more digital memory disks, a motor coupled with the disk(s) and for rotating the disk(s), a corresponding data head for each disk, a magnetically responsive element coupled with the data head(s) and a magnetic field generator. The docking station may comprise an interface controller communicatively coupled with an external device or system, and for enabling the external device or system to control the operation of the cartridge, such as the state of the cartridge motor and the position of the data head(s) relative to each corresponding digital memory disk.

In certain alternate preferred embodiments of the present invention the docking station further comprises a mechanical feature and the cartridge further comprises a latching element, wherein the mechanical feature and the latching element are configured to enable detachable attachment of the cartridge with the docking station.

In certain still alternate preferred embodiments of the present invention the docking station further comprises guide posts and the cartridge further comprises guide receivers, wherein the guide posts and the guide post receivers are configured to enable positioning of the cartridge relative to the docking station to support detachable attachment of the cartridge with the docking station.

### BRIEF DESCRIPTION OF THE DRAWINGS

The accompanying drawings, which are incorporated in and constitute a part of the specification, illustrates a preferred embodiment of the invention and, together with a general description given above and the detailed description of the preferred embodiment given below, serve to explain the principles of the invention.

FIG. 1 is a schematic diagram of a first preferred embodiment of the present invention.

FIG. 2 is a schematic diagram of a second preferred embodiment of the present invention.

FIG. 3 is an illustration of a first system provided in accordance with the first preferred embodiment of the method of the present invention of FIG. 1.

FIG. 4 is an illustration of the docking station and a magnetic generator of the first system of FIG. 3.

FIG. 5 is an illustration of a second system provided in accordance with the second preferred embodiment of the method of the present invention of FIG. 2.

FIG. 6 is an illustration of the docking station with a magnetic generator inside the second system of FIG. 5.

### DETAILED DESCRIPTION OF PREFERRED EMBODIMENTS

The following description is provided to enable any person skilled in the art to make and use the invention and sets forth the best modes contemplated by the inventor of carrying out his or her invention. Various modifications, however, will remain readily apparent to those skilled in the art, since the generic principles of the present invention have been defined herein.

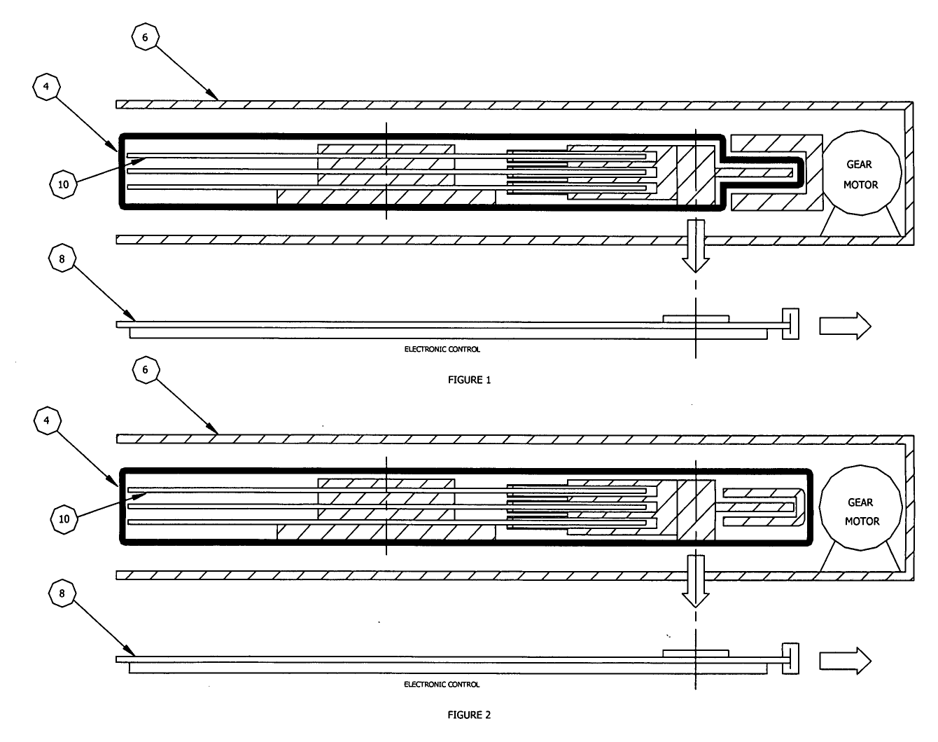

Referring now generally the Figures and particularly to FIG. 1, FIG. 1 is a schematic diagram of a first preferred embodiment of the present invention, or first design 2. First design 2 includes a first cartridge 4 and a first docking station 6. The first docking station 6 is communicatively coupled to an external electronic system 8. The external electronic system 8 may be suitable electronic system or device known in the art, such as a personal computer, a hand-held digital assistant, or a peripheral device controller. The first cartridge includes an enclosure, a plurality of digital memory disks 10, or disks 10, a disk motor, a data head structure, and a plurality of signal pathways. The enclosure may optionally surround and hermetically seal the disks 10, the motor the data head structure, and/or the plurality of signal pathways. The data head structure includes a central body, a plurality of data heads, and a magnetically responsive element. Each data head is configure to read data, and optionally write data, to a corresponding disk 10. The central body includes (1) a central attachment feature by which the central body is rotatably attached to and within the enclosure, and (2) a plurality of arms with each arm holding one data head. The magnetically responsive element is mechanically coupled to the central body of the data head structure, and the magnetically responsive coil element is positioned within the first cartridge 4 positioned to enable a magnetic field generator of the first docking station 6 to affect the position of the magnetically responsive element in relation to the enclosure and the disks 10 when the first cartridge 4 is operationally and detachably coupled with the first docking station 6. The first docking station thereby by controls the position of the plurality of the data heads relative to the disks by causing movement of the magnetically responsive coil element by the influence of the magnetic field generator and causing the data head structure to revolve about a data head structure axis, wherein the data head structure axis is substantially normal the plurality of disks and passes through the central body at a point approximate to the central attachment feature.

The plurality of signal pathways include a plurality of signal traces and a signal interface. The plurality of signal traces are each individually coupled to a data head and carry electrical signals from, and optionally to, the data head to, and optionally from, the signal interface. The signal interface is configured to detachably and communicatively couple with a connector of the first docking station 6. The connector of the first docking station 6 provides a first set of signal lines that carry the electrical signals transmitted from the data heads to a disk dive controller of the first docking station 6. A second set of signal lines carry electrical signals to and from the disk drive controller to the external system via a second connector.

Referring now generally the Figures and particularly to FIG. 2, FIG. 2 is a schematic diagram of a second preferred embodiment of the present invention, or second design 102. Second design 102 includes a second cartridge 104 and a second docking station 106. The second docking station 106 is communicatively coupled to an external electronic system 8. The second cartridge 104 includes an enclosure, a plurality of digital memory disks 10, or disks 10, a disk motor, a data head structure, a plurality of signal pathways and a magnetic field generator. The enclosure may optionally surround and hermetically seal the disks 10, the motor the data head structure, the plurality of signal pathways, and/or the magnetic field generator. The data head structure includes a central body, a plurality of data heads, and a magnetically responsive element. Each data head is configure to read data, and optionally write data, to a corresponding disk 10. The central body includes (1) a central attachment feature by which the central body is rotatably attached to and within the enclosure, and (2) a plurality of arms with each arm holding one data head. The magnetically responsive coil element and the magnetic field generator are electro-mechanically coupled to the central body of the data head structure, and the magnetic field generator is positioned within the second cartridge 104 to enable the magnetically responsive coil element to affect the position of the data heads in relation to the enclosure and the disks 10 when the second cartridge 104 is operationally and detachably coupled with the second docking station 106. The second docking station thereby by controls the position of the plurality of the data heads relative to the disks by sending control signals to the magnetically responsive element within the magnetic field generator inside the second cartridge 104 and causing the data head structure to revolve about a data head structure axis.

The plurality of signal pathways include disk(s) motor control lines, magnet control lines and the plurality of head signal traces communicatively connected with the disk drive controller of the first docking station via the mating connectors.

The drive control lines of the second cartridge are communicatively connected with the disk drive controller of second docking station via the mating connectors.

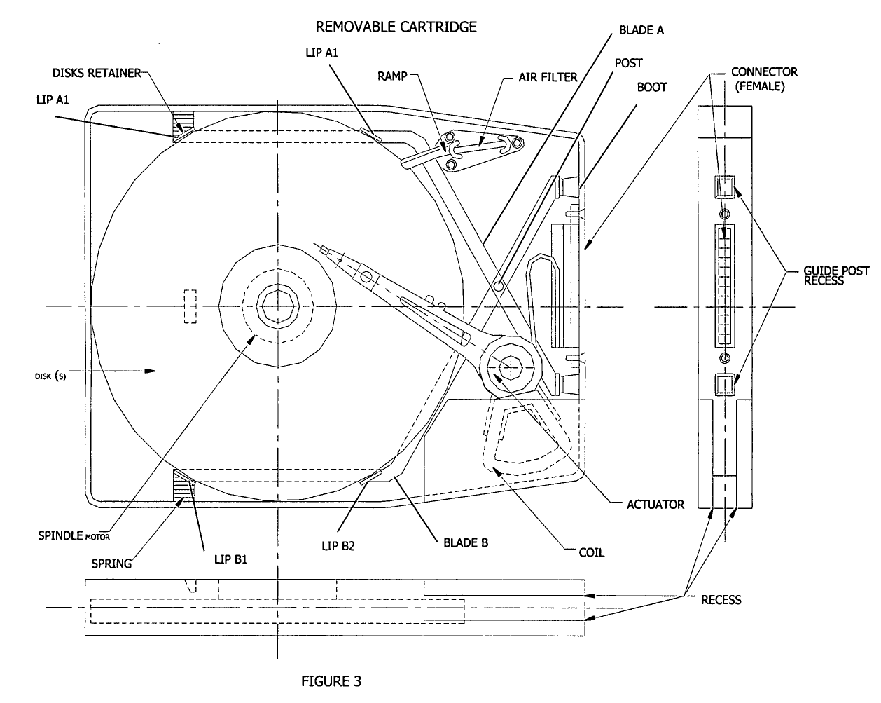

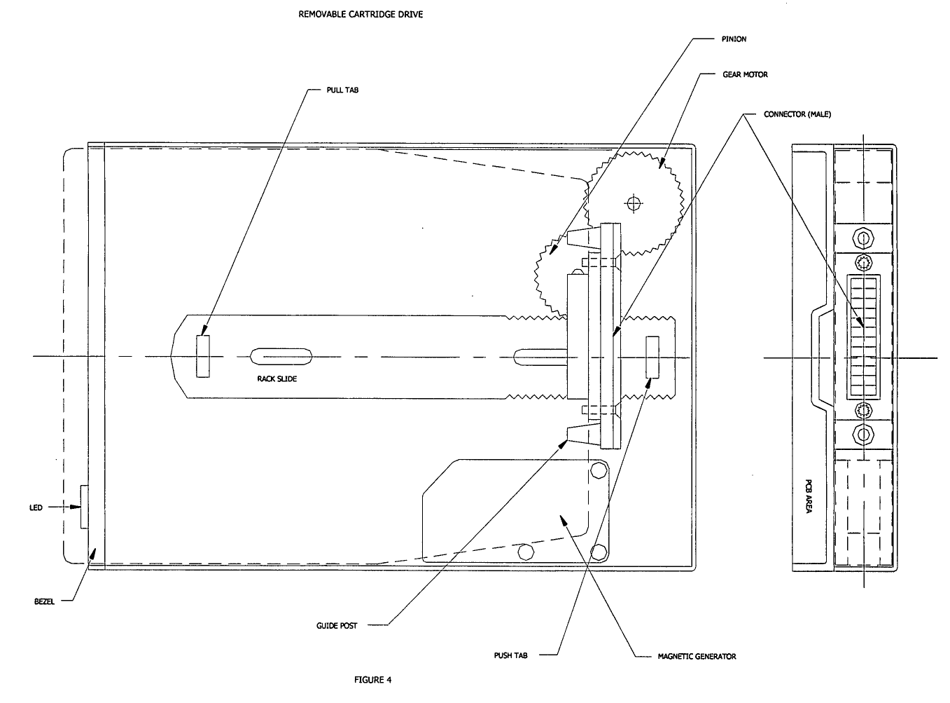

Referring now generally the Figures and particularly to FIG. 3, FIG. 3 is a detail drawing of a first system provided in accordance with the first design of FIG. 1 with the magnetically responsive coil element and a relieved portion of the enclosure proximate to the magnetically responsive coil element.

Referring now generally the Figures and particularly to FIG. 4, FIG. 4 is an illustration of the first system provided in accordance with the first design of FIG. 1.

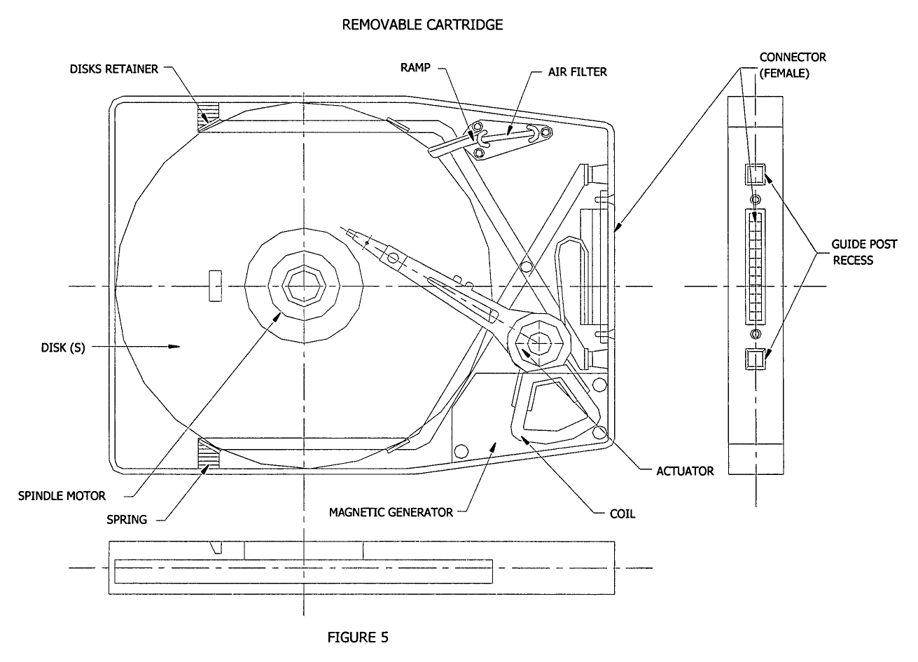

Referring now generally the Figures and particularly to FIG. 5, FIG. 5 is a detail drawing of the second system including the magnetically responsive coil element, the magnetic generator, and an unrelieved portion of the enclosure proximate to the magnetically responsive element.

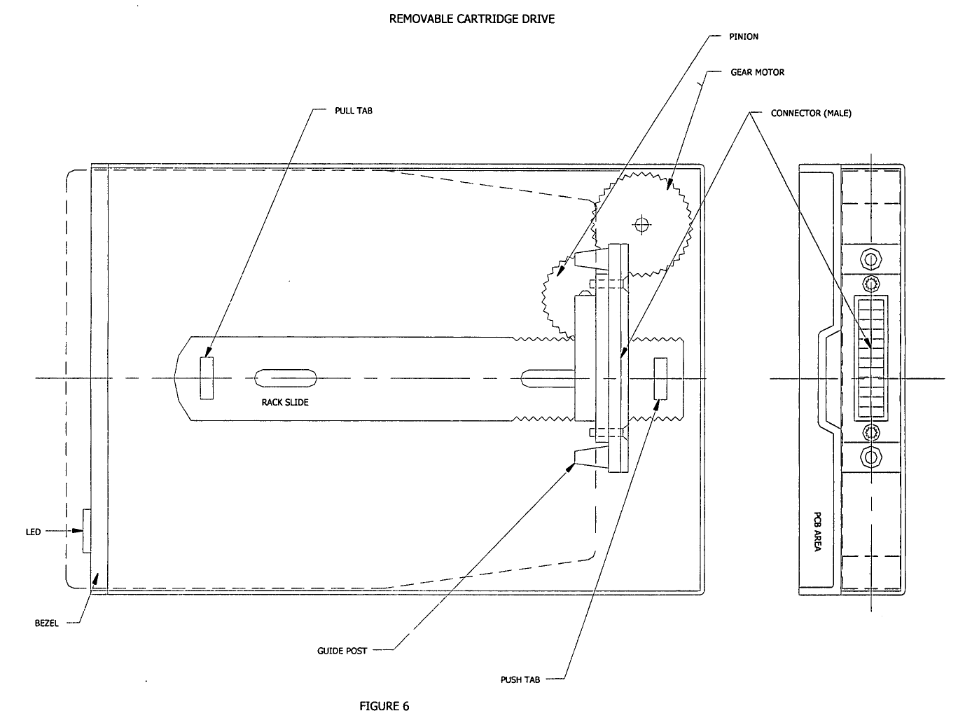

Referring now generally the Figures and particularly to FIG. 6, FIG. 6 is an illustration of a second system provided in accordance with the second design of FIG. 2.

Referring now generally the Figures and particularly to FIG. 3 and FIG. 5, A disk retaining feature, or disk retainer is included inside the cartridge to prevent damage to the disk while the disk is disengaged from a docking station. A Blade A and a Blade B each are pushed towards the disk by one of a pair of Springs positioned on a wall of the cartridge. Lip A1 and Lip A2 of the Blade A touch and secure the disk, while the remainder of Blade A does not touch the disk. Correspondingly, a Lip B1 and Lip B2 of the Blade B touch and secure the disk, while the remainder of Blade B does not touch the disk. To release the disk and disengage the lips A1, A2, B1 and B2 from the disk, disk retainer moves a scissor action, where Blade A and Blade B are rotatably coupled about a Post.

When the disk is in operation, the Blades A and B are opened to decouple from and release the disks. The opening of the Blades A and B is effected by the insertion of the two guide posts of the docking station into the cartridge, whereby the Blades A and B are rotated about the Post and the Lips A1, A2, B1 and B2 are thereby moved away from the disk. During the insertion of the cartridge, the guide posts press on the links through the receiver cavity sealed by a rubber boot. The flexible rubber boot acts as a sock and provides entry of the post into the cartridge without breaking the air seal.

The disk retaining feature includes feature prevents or reduces the magnitude of deformation imposed on the disk during transportation of the cartridge. For example, the disk retainer prevents disks from getting damaged, or reduces damage incurred, if the cartridge were to be dropped on the floor. Without Disk Retainer the disks will more likely and more severely bent like an umbrella top when dropped on the floor.

The disk retainer may be made of a suitable plastic, metal, composite material or other suitable materials known in the art, in singularity or combination.

Many features have been listed with particular configurations, options, and embodiments. Any one or more of the features described may be added to or combined with any of the other embodiments or other standard devices to create alternate combinations and embodiments. The features of one of the functions may also be used with other functions.

Although the examples given include many specificities, they are intended as illustrative of only one possible embodiment of the invention. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

I claim:

1. A portable memory device, the portable memory device removably coupled with an electronic system, comprising:
an enclosure;
at least one digital memory disk, the at least one digital memory disk rotatably coupled within the enclosure, and the one disk rotatable about an axis of motion;
a motor, the motor coupled with the at least one digital memory disk and for spinning the at least one digital memory disk about the axis of motion;
a data head, the data head coupled within the enclosure and configured for reading data from the at least one digital memory disk; and
a mechanical disk(s) retainer latch assembly to prevent disk motion;
a plurality of signal pathways coupled with the data head and for transmitting digital signals to and from the electrical system and the data head.

2. The portable memory device of claim 1, wherein the electronic system has a mechanical feature, and the portable memory device further comprises a latching element, the latching element configured to detachably couple the portable device with the mechanical feature of the electronic system.

3. The device of claim 1, wherein the electronic system has a guide post, and the portable memory device further comprises a guide post receiver, the guide post configured to substantially insert into the guide post receiver of the portable memory device.

4. The portable memory device of claim 1, wherein the electronic system has a magnetic field generator, and the portable memory device comprises a magnetically responsive coil element which is coupled with the data head and located within the enclosure, whereby the location of the data head within the enclosure is adjustable by the magnetic field generator coupled with the electronic system.

5. The portable memory device of claim 1, wherein the portable memory device further comprises:
a magnetically responsive coil element, coupled with the data head;
a magnetic field generator, the magnetic field generator located within the enclosure, whereby the location of the data head within the enclosure is adjustable by the magnetic field generator under direction of the electronic system.

6. The portable memory device of claim 4, wherein the electronic system has a mechanical feature, and the portable memory device further comprises a latching element, the latching element configured to detachably couple the portable device with the mechanical feature of the electronic system.

7. The portable memory device of claim 5, wherein the electronic system has a mechanical feature, and the portable memory device further comprises a latching element, the latching element configured to detachably couple the portable device with the mechanical feature of the electronic system.

8. The device of claim 4, wherein the electronic system has a guide post receiver, and the portable memory device further comprises a guide post receiver, the guide post configured to substantially insert into the guide post receiver of the portable memory device.

9. The device of claim 5, wherein the electronic system has a guide post receiver, and the portable memory device further comprises a guide post receiver, the guide post configured to substantially insert into the guide post receiver of the portable memory device.

10. The device of claim 1, wherein the at least one digital memory disk is an optical data storage disk, and the data head is an optical data read head.

11. The device of claim 1, wherein the at least one digital memory disk is an optical data storage disk, and the data head is an optical data read and write head.

12. The device of claim 1, wherein the at least one digital memory disk is a magnetic data storage disk, and the data head is a magnetic data read head.

13. The device of claim 1, wherein the at least one digital memory disk is a magnetic data storage disk, and the data head is a magnetic data read and write head.

14. A memory device, the memory device communicatively coupled with an electronic system, and the memory device comprising:
a docking station, the docking station detachably communicatively coupled with the electronic device and comprising a controller, the controller for receiving instructions from the electronic system and for providing information to the electronic system; and
a cartridge, the cartridge configured for detachable coupling with the docking station, and the cartridge comprising an enclosure, at least one digital memory disk, a motor, a data head, a disk retaining latch assembly and a plurality of signal pathways;
the at least one digital memory disk rotatably coupled within the enclosure, and the one at least one digital memory disk rotatable about an axis of motion;
the motor coupled with the at least one digital memory disk and for spinning the at least one digital memory disk about the axis of motion;
the data head coupled within the enclosure and configured for reading data from the at least one digital memory disk; and
the plurality of signal pathways coupled with the data head and the controller of the docking station, and the plurality of signal pathways for transmitting digital signals via the docking station to and from the electrical system and the data head.

15. The portable memory device of claim 14, wherein the docking station further comprises a mechanical feature, and the portable memory device further comprises a latching element, the latching element configured to detachably couple the portable device with the mechanical feature of the docking station.

16. The device of claim 14, wherein the docking station further comprises a guide post, and the portable memory device further comprises a guide post receiver, the guide post configured to substantially insert into the guide post receiver of the portable memory device.

17. The portable memory device of claim 14, wherein the docking station has a magnetic field generator, and the portable memory device further comprises a magnetically responsive element which is coupled with the data head and located within the enclosure, whereby the location of the data head within the enclosure is adjustable by the magnetic field generator coupled with the electronic system.

18. The portable memory device of claim 14, wherein the portable memory device further comprises:
a magnetically responsive element coupled with the data head;
a magnetic field generator, the magnetic field generator located within the enclosure, whereby the location of the data head within the enclosure is adjustable by the magnetic field generator under direction of the electronic system.

19. The portable memory device of claim 17, wherein the docking station has a mechanical feature, and the portable memory device further comprises a latching element, the latching element configured to detachably couple the portable device with the mechanical feature of the docking station.

20. The portable memory device of claim 18, wherein the docking station has a mechanical feature, and the portable memory device further comprises a latching element, the latching element configured to detachably couple the portable device with the mechanical feature of the docking station.

21. The device of claim 16, wherein the docking station has a guide post, and the portable memory device further comprises a guide post receiver, the guide post configured to substantially insert into the guide pin receiver of the portable memory device.

22. The device of claim 16, wherein the at least one digital memory disk is an optical data storage disk, and the data head is an optical data read head.

23. The device of claim 16, wherein the at least one digital memory disk is a magnetic data storage disk, and the data head is a magnetic data read and write head.
